(19) United States
(12) Patent Application Publication
(10) Pub. No.: US 2026/0361861 A1
(43) Pub. Date: Nov. 12, 2026

(54) ENCODING METHOD, DECODING METHOD, AND COMPUTER-READABLE STORAGE MEDIUM

(71) Applicant: GUANGDONG OPPO MOBILE TELECOMMUNICATIONS CORP., LTD., Dongguan (CN)

(72) Inventors: Junyan HUO, Dongguan (CN); Yanzhuo MA, Dongguan (CN); Fuzheng YANG, Dongguan (CN); Zhenyao ZHANG, Dongguan (CN); Ming LI, Dongguan (CN)

(21) Appl. No.: 19/730,376

(22) Filed: Jul. 2, 2026

Related U.S. Application Data
(63) Continuation of application No. PCT/CN2024/070903, filed on Jan. 5, 2024.

(51) Int. Cl. H04N 19/11; H04N 19/105; H04N 19/176

(52) U.S. Cl. CPC H04N 19/11; H04N 19/105; H04N 19/176

(57) ABSTRACT

An encoding method, a decoding method, and a computer-readable storage medium are provided. The decoding method includes following operations. A bitstream is decoded to determine a prediction parameter of a current block. In response to the prediction parameter indicating determining a prediction value for the current block using a Template based Intra Mode Derivation (TIMD) mode, a prediction cost value of a candidate prediction mode is determined based on a template of the current block. The candidate prediction mode includes one or more PLANAR intra prediction modes. A target prediction mode of the current block is determined according to the prediction cost value of the candidate prediction mode. A prediction value of the current block is determined according to the target prediction mode.

### CROSS-REFERENCE TO RELATED APPLICATION

This is a continuation application of International Patent Application No. PCT/CN2024/070903, filed on Jan. 5, 2024, the disclosure of which is hereby incorporated by reference in its entirety.

### BACKGROUND

Template based Intra Mode Derivation (TIMD) technology, with taking the part of the L-shaped reconstructed pixels neighboring to the current block as a template, the predicted values of the template are calculated under different prediction modes, and template error values of the predicted values and reconstructed values of the template under different prediction modes are obtained, and the optimal prediction mode is selected according to the template error values to predict the current block.

However, the optimal prediction mode selected by TIMD technology has large deviation in some scenarios in the actual encoding process, resulting in low prediction accuracy of the current block.

### SUMMARY

The present disclosure relates to the technical field of video codec, and in particular to an encoding method, a decoding method, and a non-transitory computer-readable storage medium, to improve the prediction effect of the TIMD mode, thereby improving the efficiency of encoding and decoding.

The technical solution of the embodiment of the present disclosure is implemented as follows.

A first aspect of the embodiment of the present disclosure provides a decoding method applied to a decoder, which includes the following operations.

A bitstream is decoded to determine a prediction parameter of a current block.

In response to the prediction parameter indicating determining a prediction value for the current block using a Template based Intra Mode Derivation (TIMD) mode, a prediction cost value of a candidate prediction mode is determined based on a template of the current block. The candidate prediction mode includes one or more PLANAR intra prediction modes.

A target prediction mode of the current block is determined according to the prediction cost value of the candidate prediction mode.

A prediction value of the current block is determined according to the target prediction mode.

A second aspect of an embodiment of the present disclosure provides an encoding method applied to an encoder, which includes the following operations.

A prediction cost value of a candidate prediction mode is determined based on a template of a current block. The candidate prediction mode includes one or more PLANAR intra prediction modes.

A target prediction mode of the current block is determined according to the prediction cost value of the candidate prediction mode.

A prediction value of the current block is determined according to the target prediction mode.

An encoding decision is performed based on the prediction value of the current block to determine a prediction parameter of the current block. The prediction parameter indicates whether to determine the prediction value of the current block using a Template based Intra Mode Derivation (TIMD) mode.

The prediction parameter is encoded and the obtained encoded bits are written into a bitstream.

A third aspect of an embodiment of the present disclosure provides a non-transitory computer-readable storage medium having a computer program and a bitstream stored thereon, wherein the computer program, when executed by a processor, enables the processor to perform following steps to generate the bitstream: determining a prediction cost value of a candidate prediction mode based on a template of a current block, wherein the candidate prediction mode comprises one or more planar intra prediction modes; determining a target prediction mode of the current block according to the prediction cost value of the candidate prediction mode; determining a prediction value of the current block according to the target prediction mode; performing an encoding decision based on the prediction value of the current block to determine a prediction parameter of the current block, wherein the prediction parameter indicates whether to determine the prediction value of the current block using a Template based Intra Mode Derivation mode; and encoding the prediction parameter, and writing the obtained encoded bits into the bitstream.

The embodiments of the present disclosure provide an encoding method, a decoding method, an encoder, a decoder, and a storage medium. Whether at an encoding end or a decoding end, in case that the prediction value of the current block is determined by using a Template based Intra Mode Derivation (TIMD) mode, the prediction cost value of candidate prediction mode is determined based on a template of the current block. The candidate prediction mode includes one or more planar intra prediction modes. A target prediction mode of the current block is determined according to the prediction cost value of the candidate prediction mode. A prediction value of the current block is determined according to the target prediction mode. In this way, the correlation between the template and the current block is fully utilized, and one or more PLANAR intra prediction modes are added as the candidate prediction mode for the TIMD mode, so that the TIMD mode may adaptively select a matching prediction mode based on the template, thereby improving the prediction effect of the TIMD mode, and improving the efficiency of the encoding and decoding.

### BRIEF DESCRIPTION OF THE DRAWINGS

FIG. 1 is a schematic composition block diagram of an encoder according to an embodiment of the present disclosure;

FIG. 2 is a schematic composition block diagram of a decoder according to an embodiment of the present disclosure;

FIG. 3 is a schematic diagram of a network architecture of a codec system according to an embodiment of the present disclosure;

FIG. 4 is a schematic flowchart of prediction of a TIMD mode according to an embodiment of the present disclosure;

FIG. 5 is a schematic diagram of a template position and a template reference region according to an embodiment of the present disclosure;

FIG. 6 is a schematic diagram of a reference pixel region of a TIMD mode according to an embodiment of the present disclosure;

FIG. 7 is a schematic flowchart of a decoding method according to an embodiment of the present disclosure;

FIG. 8 is a schematic diagram of positions of neighboring blocks according to an embodiment of the present disclosure;

FIG. 9 is a schematic diagram of positions of a current block and reference pixels according to an embodiment of the present disclosure;

FIG. 10 is a schematic flowchart of an encoding method according to an embodiment of the present disclosure;

FIG. 11 is a schematic diagram of a composition structure of an encoder according to an embodiment of the present disclosure;

FIG. 12 is schematic diagram of a specific hardware structure of an encoder according to an embodiment of the present disclosure;

FIG. 13 is a schematic diagram of a composition structure of a decoder according to an embodiment of the present disclosure;

FIG. 14 is a schematic diagram of a composition structure of a decoder according to an embodiment of the present disclosure; and

FIG. 15 is a schematic diagram of a composition structure of a codec system according to an embodiment of the present disclosure.

### DETAILED DESCRIPTION

In order to exhaustively understand the characteristics and technical contents of the embodiments of the present disclosure, the implementation of the embodiments of the present disclosure will be described in detail below with reference to the accompanying drawings, which are for reference and illustration only, and are not used to limit the embodiments of the present disclosure.

Unless otherwise defined, all technical and scientific terms used herein have the same meaning as commonly understood by those skilled in the art belonging to the present disclosure. The terms used herein are for the purpose of describing the embodiments of the present disclosure, rather than limiting the disclosure.

In the following description, the expression “some embodiments” describes a subset of all possible embodiments, but it is understood that the expression “some embodiments” may be the same subset or different subsets of all possible embodiments, and may be combined with each other without conflict. It should also be pointed out that, reference to the terms “first\second\third” in the embodiments of the present disclosure are merely to distinguish similar objects and does not represent a specific order of the objects, and it is understood that “first\second\third” may be interchanged in a specific order or a priority order, to enable the embodiments of the present disclosure described herein may be implemented in an order other than that illustrated or described herein.

Before further detailed description of the embodiments of the present disclosure, the nouns and terms involved in the embodiments of the present disclosure will be described first, and the nouns and terms involved in the embodiments of the present disclosure are applicable to the following explanations:
Coding Block (CB);
Block Matching (BM);
Coding Unit (CU);
Block Vector (BV);
Motion Vector (MV);
Sum of Absolute Difference (SAD);
Sum of Absolute Transformed Difference (SATD);
Mean Square Error (MSE);
Sum of Squared Differences (SSD);
Mean Absolute Deviation (MAD);
Mean Square Differences (MSD);
Normalized Correlation Coefficient, (NCC);
H.266/Versatile Video Coding (VVC);
VVC Test Model, (VTM);
Template Matching (TM);
Intra Template Matching Prediction (Intra TMP);
Intra block copy (IBC);
Enhanced Compression Model (ECM);
Template based Intra Mode Derivation (TIMD).

It will be appreciated that a first color component, a second color component, and a third color component are generally used to represent the coding block in a video image. The first color component, the second color component, and the third color component are a luminance component, a blue chrominance component, and a red chrominance component, respectively. Specifically, the luminance component is usually denoted by a symbol Y, the blue chrominance component is usually denoted by a symbol Cb or U, and the red chrominance component is usually denoted by a symbol Cr or V. In this way, the video image may be represented in the YCbCr format or in the YUV format.

Hereinafter, all the embodiments of the present disclosure will be described in detail with reference to the accompanying drawings.

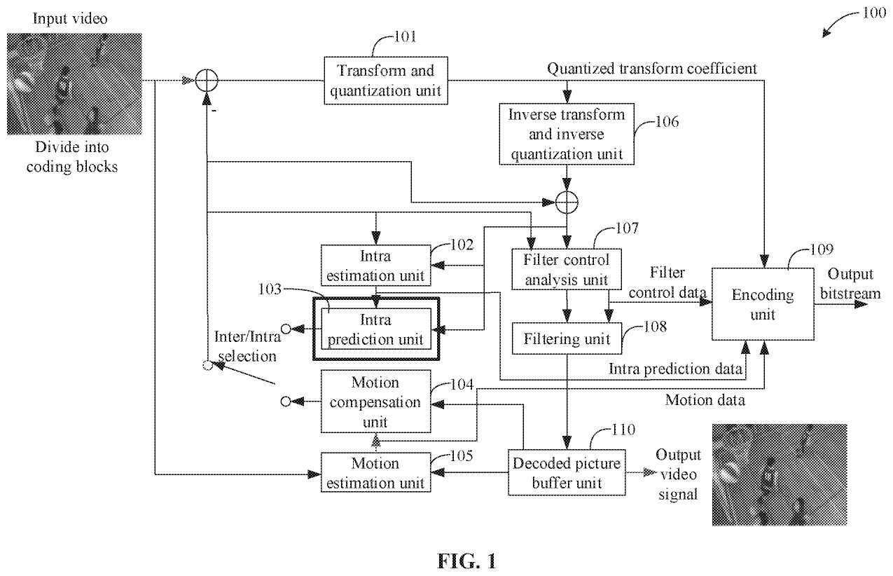

FIG. 1 is a schematic composition block diagram of an encoder according to an embodiment of the present disclosure. As shown in FIG. 1, an encoder (specifically, a “video encoder”) 100 may include a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, an encoding unit 109 and a decoded picture buffer unit 110. The filtering unit 108 may implement deblocking filtering and Sample Adaptive OFFSET (SAO) filtering, and the encoding unit 109 may implement header information encoding and Context-based Adaptive Binary Arithmetic Coding (CABAC). For the input original video signal, a video coding block can be obtained by dividing based on coding tree units (CTUs). Then, for residual sample information obtained after intra or inter-frame prediction, the video coding block is transformed by the transform and quantization unit 101, including transforming the residual information from a sample domain to a transform domain, and quantizing the obtained transform coefficients to further reduce the bit rate. The intra estimation unit 102 and the intra prediction unit 103 are used to perform intra prediction for the video coding block. The intra estimation unit 102 and the intra prediction unit 103 are used to determine an intra prediction mode for encoding the video coding block. The motion compensation unit 104 and the motion estimation unit 105 are used to perform inter-frame prediction coding of the received video coding block with respect to one or more blocks in one or more reference frames to provide temporal prediction information. Motion estimation performed by the motion estimation unit 105 is a process of generating motion vectors that can be used to estimate the motion of the video coding block, and then the motion compensation unit 104 performs motion compensation based on the motion vectors determined by the motion estimation unit 105. After the intra prediction mode is determined, the intra prediction unit 103 is also used to provide the selected intra prediction data to the encoding unit 109, and the motion estimation unit 105 sends the calculated and determined motion vector data to the encoding unit 109. In addition, the inverse transform and inverse quantization unit 106 is used for reconstructing the video coding block, and reconstructing residual blocks in the sample domain. Blocking artifacts are removed from the reconstructed residual blocks by the filter control analysis unit 107 and the filtering unit 108, and then the reconstructed residual blocks are added to a predictive block in a frame of the decoded picture buffer unit 110 to generate reconstructed video coding blocks. The encoding unit 109 is used to encode various encoding parameters and quantized transform coefficients. In a CABAC-based encoding algorithm, the context content can be based on neighboring coding blocks, and can be used to encode information indicating the determined intra prediction mode to output a bitstream of the video signal. The decoded picture buffer unit 110 is used to store the reconstructed video coding blocks for prediction reference. With the progress of video picture coding, new reconstructed video coding blocks will be generated continuously, and will all be stored in the decoded picture buffer unit 110.

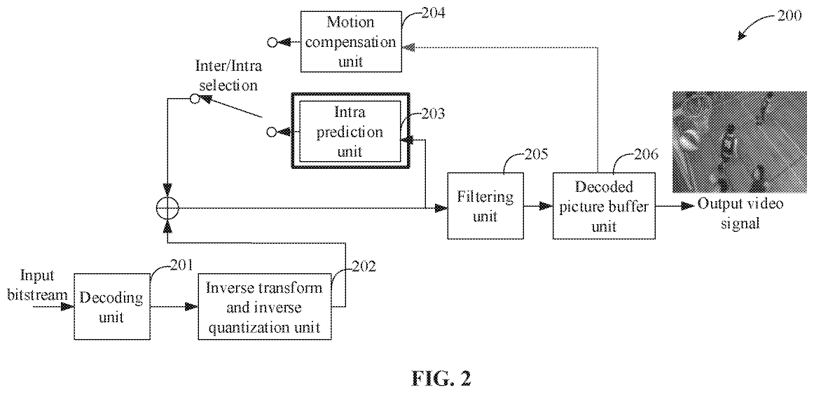

FIG. 2 is a schematic composition block diagram of a decoder according to an embodiment of the present disclosure. As shown in FIG. 2, a decoder (specifically, a “video decoder”) 200 includes a decoding unit 201, an inverse transform and inverse quantization unit 202, an intra prediction unit 203, a motion compensation unit 204, a filtering unit 205, a decoded image buffer unit 206, and the like. The decoding unit 201 may implement header information decoding and CABAC decoding, and the filtering unit 205 may implement deblocking filtering and SAO filtering. After the input video signal is subjected to the encoding process of FIG. 1, a bitstream of the video signal is output. The bitstream is input into the decoder 200 and first passes through the decoding unit 201 to obtain the decoded transform coefficients. The transform coefficients are processed by the inverse transform and inverse quantization unit 202 to generate a residual block in the pixel domain. The intra prediction unit 203 may be configured to generate prediction data for the current video decoding block based on the determined intra prediction mode and data from previously decoding blocks of the current frame or picture. The motion compensation unit 204 determines prediction information for the video decoding block by parsing the motion vector and other associated syntax elements, and uses the prediction information to generate a prediction block of the video decoding block being decoded. A decoded video block is formed by summing the residual block from the inverse transform and inverse quantization unit 202 and the corresponding prediction block generated by the intra prediction unit 203 or the motion compensation unit 204. The decoded video signal passes through the filtering unit 205 in order to remove blocking artifacts, and improve the video quality. The decoded video block is then stored in the decoded image buffer unit 206, which stores a reference picture for subsequent intra prediction or motion compensation, and is also used for the output of the video signal, i.e. to obtain the restored original video signal.

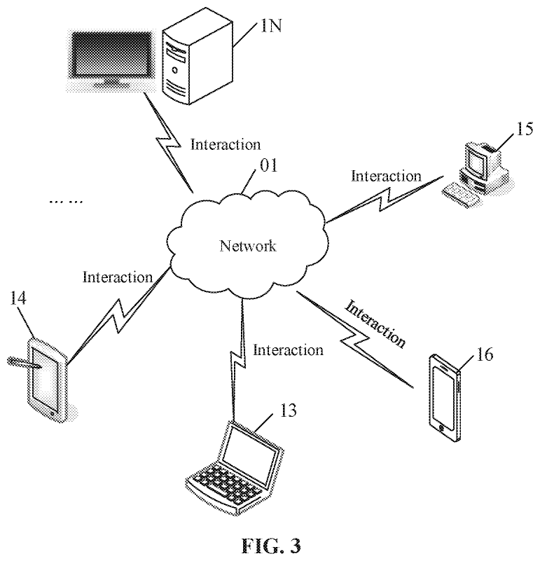

Further, an embodiment of the present disclosure also provides a network architecture of a codec system including an encoder and a decoder. FIG. 3 shows a schematic diagram of a network architecture of a codec system provided by an embodiment of the present disclosure. As shown in FIG. 3, the network architecture includes one or more electronic device 13 to IN and a communication network 01. The electronic device 13 to IN may perform video interaction via the communication network 01. The electronic device may be various types of devices having video encoding and decoding functions during implementation, and the electronic device may include for example a smartphone, a tablet, a personal computer, a personal digital assistant, a navigator, a digital telephone, a video telephone, a television, a sensing device, a server, and the like, which is not particularly limited by the embodiments of the present disclosure. In addition, the decoder or encoder described in the embodiment of the present disclosure may be the electronic device described above.

Template based Intra Mode Derivation (TIMD) is an intra prediction mode that may be used for luminance or chroma. The encoder and decoder use the same operation to obtain the final prediction value. Specifically, for a prediction mode in a given prediction mode set (e.g., most probable mode (MPM) list or the like), a template prediction value is calculated for a template region of the current block according to the mode, and a given evaluation criterion (e.g., Sum of Absolute Transformed Difference (SATD) or the like) of the template prediction value and the template reconstruction value is calculated, and a certain number (e.g., one or two) of candidate prediction modes are selected according to the size of the evaluation criterion to predict the current block.

Specifically, the process of the TIMD technology is as shown in FIG. 4.

At S1, the type and size of the template are determined.

The reconstructed brightness pixel at the template position is acquired.

According to the pixel availability of the neighboring region of the current block, whether pixels at the template position and the template reference position are available is determined. It includes but is not limited to: according to the relative positional relationship between the template and the current block, the template may be classified into upper template, left template, upper right template, lower left template, top left template and other template types, the reference of the template varies with different template types, and the template region is allowed to overlap with the reference of the template.

In addition, in order to meet the requirements of different coding blocks, the template type and the reference corresponding to the template may be flexibly combined, as shown in FIG. 5. Different types of template sizes of different coding blocks may be fixed to be the same or different. For example, different template sizes may be selected according to different sizes of the current block. Taking the template in FIG. 5 as an example for explanation, the following formula illustrates a template size set condition, uiWidth and uiHeight denote the width and height of the current block, and iTempW and iTempH denote the width and height of the adopted template:

$$upper template : \{ \begin{matrix}\{ \begin{matrix}iTempW = uiWidth \\ iTempH = 2\end{matrix} , min ( uiWidth , uiHeight ) \leq 8 \\ \{ \begin{matrix}iTempW = uiWidth \\ iTempH = 4\end{matrix} , min ( uiWidth , uiHeight ) > 8\end{matrix}$$

$$left template : \{ \begin{matrix}\{ \begin{matrix}iTempW = 2 \\ iTempH = uiHeight\end{matrix} , & min ( uiWidth , uiHeight ) \leq 8 \\ \{ \begin{matrix}iTempW = 4 \\ iTempH = uiHeight\end{matrix} , & min ( uiWidth , uiHeight ) > 8\end{matrix}$$

$$Min ( x , y ) = \{ \begin{matrix}x , & x \leq y \\ y , & x > y\end{matrix}$$

At S2, pixels in the reference are obtained.

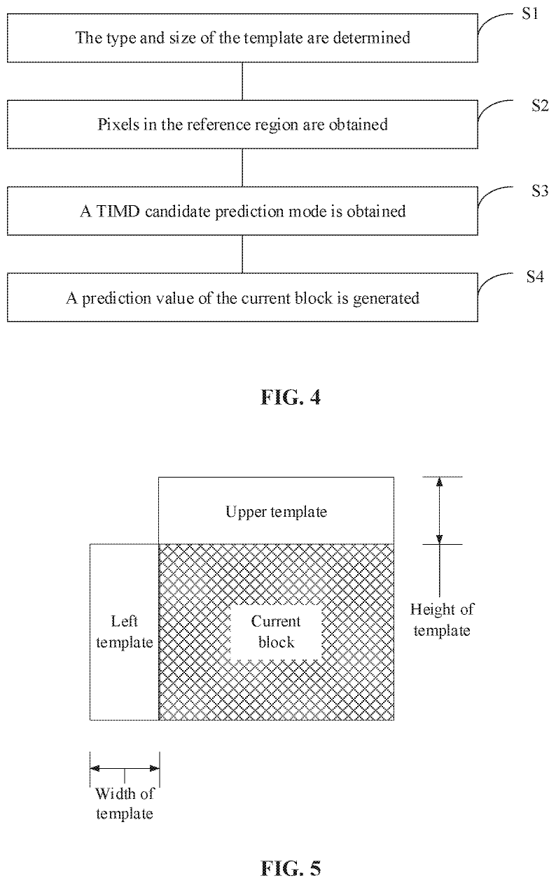

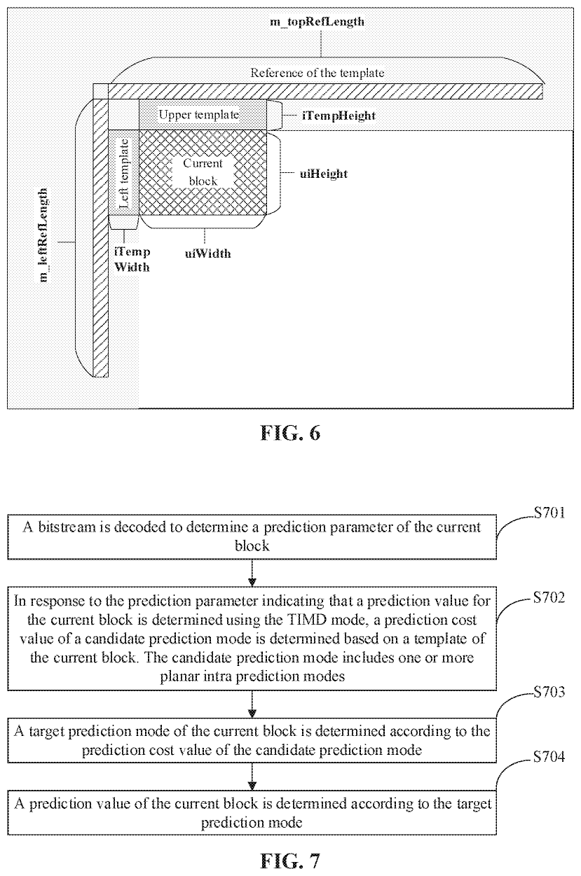

As shown in FIG. 6, the reference of the template that may be utilized by the TIMD technique includes a reconstructed pixel region neighboring the left side of the left template and a reconstructed pixel region neighboring the upper side of the upper template. It is assumed that the length of the reconstructed pixel region neighboring the left side is m_leftRefLength, the length of the reconstructed pixel region neighboring the upper side is denoted as m_topRefLength, the height of the upper template is denoted as iTempHeight, the width of the left template is iTempWidth, and the width and height of the current block are denoted as uiWidth and uiHeight, thus

m_leftRefLength=(uiHeight+iTempHeight)<<3

m_topRefLength=(uiWidth+iTempWidth)<<3

At S3, a TIMD candidate prediction mode is obtained.

A list of prediction modes is constructed, the modes include, but are not limited to, the following types of modes, 67 intra prediction modes (PLANAR, direct current (DC), and 65 angle prediction modes), prediction modes (IntraTmp, IBC, etc.) involving block vectors, and the like. The construction order of the list may be including but not limited to the following modes: a prediction mode of a neighboring coding block, a prediction mode of a non-neighboring coding block, and the like.

At S4, a prediction value of the current block is generated.

At the template region determined in S1, prediction of the modes in the list of candidate prediction modes acquired in S3 is performed.

By traversing different prediction modes, multiple sets of prediction information in the template region may be obtained, and the optimal prediction mode may be selected according to an evaluation criterion. For example, the Sum of Absolute Difference (SAD), the Sum of Absolute Transformed Difference (SATD), the Sum of Squared Errors (SSE), the Mean Absolute Deviation (MAD), the Mean Absolute Error (MAE), the Mean Square Error (MSE), and the like may be selected.

The SATD taken as an example includes but not limited to the following processing methods.

If there are a plurality of templates, the SATDs of the plurality of templates are accumulated to obtain a SATD sum, and an optimal prediction mode is selected by using the size of the SATD sum.

Alternatively, STADs of different templates are calculated respectively, and an average value of the number of pixels in the template region is divided by the SATD to select the optimal prediction mode.

In addition, if the list of prediction modes acquired in S2 has been traversed during S4, the selected optimal prediction mode may be regulated to obtain one or more prediction modes that have not been traversed, and the processes of template prediction and selection of the optimum in S3 and S4 may be performed.

In addition, the optimal prediction mode includes, but is not limited to one mode, and a plurality of optimal prediction modes may be selected if a condition is satisfied. The condition includes, but is not limited to, the SATD of the second prediction model is less than twice that of the first prediction model, and the like.

Then, a prediction process of the above selected prediction mode is performed on the current coding block.

If only one prediction mode is selected in S4, prediction of only the prediction mode may be performed.

If a plurality of prediction modes are selected in S4, weighted prediction of the plurality of prediction modes is performed, and the weighting coefficient are obtained from the SATD calculated in S4, are averaged weighting, and the like, which is not limited thereto.

For example, iBestMode is the first prediction mode, iSecondaryMode is the second prediction mode, and predSamples [x] [y] are prediction values of the current block.

If only one candidate mode is selected by the TIMD, the weighted fusion is not performed, and the current coding block is predicted by using iBestMode to obtain the prediction value. That is, the predSamples [x] [y] is directly obtained by the corresponding method of prediction mode, x=0 . . . uiWidth−1, y=0 . . . uiHeight−1.

If more than one candidate mode is selected by the TIMD, the evaluation criterion of iBestMode and iSecondaryMode are uiBestCost and uiSecondaryCost, respectively.

The TIMD technology decides whether to apply weighted fusion based on the size of uiBestCost and uiSecondaryCost, which is described as follows:

If uiSecondaryCost>=2*uiBestCost, the weighted fusion is not applied, and the current coding block is predicted by using iBestMode for prediction to obtain the predicted value.

If uiSecondaryCost <2*uiBestCost, the weighted fusion is applied. The weight of iBestMode is set to be weight1 and the weight of iSecondaryMode is set to be weight2, which is described as follows:

weight1=uiSecondaryCost/(uiBestCost+uiSecondaryCost)

weight2=1−weight1

The current coding block obtains two prediction values (pelPred [x][y] and pelPredFusion [x][y], where x=0 . . . nTbW−1, y=0 . . . nTbH−1) by using iBestMode and iSecondaryMode. After that, weighted fusion is applied to obtain the final prediction value predSamples [x][y], which is described as follows:

predSamples[x][y]=pelPred[x][y]*weight1+pelPredFusion[x][y]*weight2

However, in the actual encoding process, the optimal prediction mode selected by TIMD technology has large deviation in some scenarios, which results in low prediction accuracy of the current block.

Based on this, the embodiment of the present disclosure provides an encoding method and a decoding method, in which, the correlation between the template and the current block is fully utilized, and one or more PLANAR intra prediction modes are added as the candidate prediction modes for the TIMD mode, so that the TIMD mode may adaptively select a matching prediction mode based on the template, thereby improving the prediction effect of the TIMD mode and improving the efficiency of the encoding and decoding.

It should be noted that the method of the embodiment of the present disclosure is mainly applied in the intra prediction unit 103 shown in FIG. 1, and the intra prediction unit 203 shown in FIG. 2. That is to say, the method of the embodiment of the present disclosure may be applied to either an encoder or a decoder, and may be applied to both an encoder and a decoder, which is not specifically limited in the embodiments of the present disclosure.

It should also be noted that, when the method is applied to the encoding end, the “current block” refers to a coding block on which intra prediction is to be performed, and also referred to as a “current coding block”. When the method is applied to the decoding end, the “current block” refers to a decoding block on which intra prediction is to be performed, and also referred to as a “current decoding block”.

FIG. 7 is a schematic flowchart of a decoding method according to an embodiment of the present disclosure. As shown in FIG. 7, the method may include the operations S701, S702, S703 and S704.

At S701, a bitstream is decoded to determine a prediction parameter of current block.

It should be noted that the prediction parameter indicates whether a prediction value for the current block is determined using a Template based Intra Mode Derivation (TIMD) mode. If the prediction parameter indicates that the prediction value of the current block is determined using the TIMD mode, the subsequent step of performing prediction using the TIMD mode in the embodiment of the present disclosure is executed, and if the prediction parameter indicates that the prediction value of the current block is not determined using the TIMD mode, the prediction is performed using other prediction modes.

Exemplarily, the prediction parameter includes at least a first syntax element for indicating whether the prediction value of the current block is determined using a Template based Intra Mode Derivation (TIMD) mode, and when the value of the first syntax element is 0, the prediction value of the current block is not determined using the TIMD mode. When the value of the first syntax element is 1, the prediction value of the current block is determined using the TIMD mode.

In some embodiments, the method further includes determining a prediction parameter of the current block according to reference information of the current block. The reference information of the current block includes at least one of: a reference sample value of a reconstructed reference block of the current block, prediction information of the reference block, a size of the current block, a syntax element of the bitstream, and the like. That is, whether the current block uses the TIMD mode may be implicitly derived from the reference information of the current block.

At S702, in a case that the prediction parameter indicates determining a prediction value for the current block using the Template based Intra Mode Derivation (TIMD) mode, a prediction cost value of a candidate prediction mode is determined based on a template of the current block. The candidate prediction mode includes one or more planar intra prediction modes.

In some embodiments, the method further includes determining the candidate prediction mode for the current block. The candidate prediction mode includes at least one or more planar intra prediction modes. Exemplarily, the one or more planar intra prediction modes include one or more of the planar prediction mode (PLANAR mode), a horizontal planar prediction mode (PLANAR_HOR mode), a vertical planar prediction mode (PLANAR_VER mode), and the like. The candidate prediction mode may also include other intra prediction modes different from the planar intra prediction modes.

Exemplarily, one or more intra prediction modes in a preset list of intra prediction modes are selected as the candidate prediction mode.

Exemplarily, the candidate prediction mode is determined based on the prediction mode of the reconstructed reference block of the current block. The reference block includes neighboring blocks and/or non-neighboring blocks of the current block. The reference block may include one or more neighboring blocks, which may be a left neighboring block, a lower left neighboring block, an upper right neighboring block, an upper neighboring block, a top left neighboring as shown in FIG. 8. The reference block may include one or more non-neighboring blocks. The reference block may include one or more neighboring blocks and one or more non-neighboring blocks.

In some embodiments, the operation that the candidate prediction mode is determined based on the prediction mode of the reconstructed reference block of the current block includes operations as follows. In a case that the prediction mode of the reference block includes the first planar intra prediction mode, it is determined that the candidate prediction mode includes the first planar intra prediction mode. The first planar intra prediction mode includes one or more planar intra prediction modes. In a case that the prediction mode of the reference block does not include the first planar intra prediction mode, it is determined that the candidate prediction mode includes the prediction mode of the reference block and the first planar intra prediction mode. That is, whether the candidate prediction mode includes the planar intra prediction mode and how many of planar intra prediction modes are included in the candidate prediction mode, are related to the prediction mode of the reference block, the candidate prediction mode includes one or more intra prediction modes in the reference block. The first planar intra prediction mode may be any planar intra prediction mode or a specific prediction mode. Exemplarily, the first planar intra prediction mode is the PLANAR_HOR mode or the PLANAR_VER mode.

It should be noted that, in addition to the first planar intra prediction mode, the candidate prediction mode includes other prediction modes of the neighboring blocks.

In other embodiments, the operation that the candidate prediction mode is determined based on the prediction mode of the reconstructed reference block of the current block includes: determining that the candidate prediction mode includes the prediction mode of the reference block and one or more planar intra prediction modes. That is, whether the candidate prediction mode includes the planar intra prediction modes and how many of planar intra prediction modes are included, are not related to the prediction mode in the reference block, and the candidate prediction mode includes one or more preset planar intra prediction modes regardless of whether the reference block has the planar intra prediction mode.

In some embodiments, the operation that the candidate prediction mode is determined based on the prediction mode of the reconstructed reference block of the current block further includes: in a case that none of the prediction mode of the reference block is available, determining that the candidate prediction mode further includes a planar prediction mode; or in a case that the prediction mode of the reference block is available but does not include an angle prediction mode, determining that the candidate prediction mode further includes a planar prediction mode and a direct current prediction mode; or in a case that the prediction mode of the reference block includes an angle prediction mode, constructing a most probable mode (MPM) list according to prediction mode of the reference block and determining at least one wide angle prediction mode of the reference block, where the most probable mode list includes one or more prediction modes; and determining that the candidate prediction mode includes one or more prediction modes in the most probable mode list, the at least one wide angle prediction mode, the direct current prediction mode, a vertical angle prediction mode (VER mode), and a horizontal angle prediction mode (HOR mode).

In some embodiments, the operation that the candidate prediction mode is determined based on the prediction mode of the reconstructed reference block of the current block further includes: in a case that the prediction mode of the reference block includes a block-vector-based prediction mode (including IntraTmp, IBC, etc.), acquiring block vectors of one or more reference blocks; and determining a candidate block vector of the current block according to the block vectors of the one or more reference blocks. That is, if the candidate prediction mode of the current block includes the block-vector-based prediction mode, the candidate block vector of the current block is obtained according to the block vector of the reference block, for realizing the block-vector-based prediction mode of the current block.

Hereinafter, a method for determining the candidate prediction mode in the embodiment of the present disclosure will be further illustrated.

The list of prediction modes is obtained, and the candidate prediction mode includes, but is not limited to the following mode categories: 67 intra prediction modes (the PLANAR mode, the DC mode, and 65 angle prediction modes), derived modes of the PLANAR mode such as the PLANAR_HOR mode and the PLANAR_VER mode, a block-vector-based prediction mode and the like.

A construction order of the list includes, but is not limited to, a prediction mode of neighboring blocks, a prediction mode of non-neighboring blocks, and the like. The derived modes of the PLANAR mode include, but are not limited to the following construction order, which may be included in the list or may be added according to the order of neighboring blocks or non-neighboring blocks.

A manner of acquiring 67 intra prediction modes is exemplified below, in which, the candidate prediction mode is selected according to the prediction mode of neighboring blocks (left, lower left, upper right, upper, and top left neighboring blocks) of the current block.

If there is no angle prediction mode in the neighboring blocks, the candidate prediction mode includes the PLANAR mode and the DC mode.

If there is an angle prediction mode in the neighboring blocks, the candidate prediction mode includes the MPM list and a wide-angle prediction mode. If one or more of the DC mode, the HOR mode and the VER mode are not in the MPM list, they are added at the end of the MPM list.

A manner of acquiring the derived modes of the PLANAR mode is exemplified below, including but not limited to the following operations.

If there is no PLANAR_HOR mode or PLANAR_VER mode in the neighboring blocks, the candidate prediction mode does not include either the PLANAR_HOR mode or the PLANAR_VER mode.

If there is at least one of the PLANAR_HOR mode or the PLANAR_VER mode in the neighboring blocks, the candidate prediction mode also includes the PLANAR_HOR mode and/or PLANAR_VER mode of the neighboring block.

A manner of acquiring the block-vector-based prediction mode is exemplified below, in which, a block vector set is selected according to the prediction modes of the neighboring blocks (the left, lower left, upper right, upper, top left neighboring blocks) of the current coding block.

If there is no block-vector-based prediction mode in the neighboring blocks, there is no need to determine the candidate block vector.

If there is a block-vector-based prediction mode in the neighboring blocks, the candidate block vector includes a valid block vector of the neighboring blocks, the terms “valid” means that the reference block of the current block which is offset with respect to the block vector has been reconstructed.

In some embodiments, a template of the current block is predicted by using the candidate prediction mode to determine a first prediction sample value of the template of the current block. The prediction cost value of the candidate prediction mode is determined according to a first reconstruction sample value and the first prediction sample value of the template of the current block.

That is to say, by traversing different prediction modes, multiple sets of prediction information of the template may be obtained, and the optimal prediction mode may be selected according to the prediction cost value. The prediction cost value includes, but is not limited to, the Sum of Absolute Difference (SAD), the Sum of Absolute Transformed Difference (SATD), the Sum of Squared Errors (SSE), the Mean Absolute Deviation (MAD), the Mean Absolute Error (MAE), the Mean Square Error (MSE), the Rate Distortion Optimization (RDO), and the like.

At S703, a target prediction mode of the current block is determined according to the prediction cost value of the candidate prediction mode.

Exemplarily, a first intra prediction mode corresponding to a minimum prediction cost value is determined according to the prediction cost values of the candidate prediction mode. The current block is predicted according to the first intra prediction value to obtain the prediction value of the current block. The first intra prediction mode may be understood as the optimal prediction mode selected in the TIMD mode, and the current block is predicted by the optimal prediction mode to obtain the prediction value of the current block in the TIMD mode.

Exemplarily, the first intra prediction mode corresponding to the minimum prediction cost value is determined according to the prediction cost value of the candidate prediction mode. A second intra prediction mode corresponding to the second smallest cost value is determined according to the prediction cost value of the candidate prediction mode. The second intra prediction mode includes one or more intra prediction modes. Weighted prediction is performed on the current block according to the first intra prediction mode and the second intra prediction mode to determine a prediction value of the current block. The second intra prediction mode may be understood as one or more sub-optimal prediction modes selected in the TIMD mode, and the weighted prediction is performed according to multiple intra prediction modes to obtain the prediction value of the current block in the TIMD mode.

That is, the target prediction mode may include one or more intra prediction modes, and the target prediction mode selected in the TIMD mode includes or does not include the planar intra prediction mode.

The SATD is taken as an example of the prediction cost value, and a manner of determining the target prediction mode includes, but is not limited to, the following processing methods.

If there are a plurality of templates, the SATDs of the plurality of templates are accumulated to obtain a SATD sum, and the target prediction mode is selected by using the size of the SATD sum.

Alternatively, STADs of different templates are calculated respectively, and an average value of the number of pixels in the template region is divided by the SATD to select the target prediction mode.

Further, the target prediction mode includes but is not limited to one mode, and a plurality of prediction modes may be selected if a condition is satisfied. The condition includes but is not limited to, the SATD of the second intra prediction model is less than twice that of the first intra prediction model, and the like.

Then, the prediction process of the selected prediction mode is performed on the current block: if only one prediction mode is selected, only the prediction of the prediction mode may be performed, and if a plurality of prediction modes are selected, a weighted prediction of the plurality of prediction modes is performed, and the weighting coefficient are obtained from the calculated SATD, are averaged weighting, and the like.

At S704, a prediction value of the current block is determined according to the target prediction mode.

In some embodiments, the operation that a prediction value of the current block is determined according to the target prediction mode includes operations as follows. The first intra prediction mode is a horizontal planar prediction mode or a vertical planar prediction mode, the current block is predicted according to the first intra prediction mode to determine a prediction value of the current block; or the first intra prediction mode is a horizontal planar prediction mode or a vertical planar prediction mode, and the second intra prediction mode is a preset intra prediction mode, weighted prediction is performed on the current block according to the first intra prediction mode and the second intra prediction mode to determine a prediction value of the current block.

That is, when the horizontal planar prediction mode or the vertical planar prediction mode is selected as the optimal prediction mode in the TMID mode, the horizontal planar prediction mode or the vertical planar prediction mode may not involve in the weighted fusion process with other prediction modes, or only involves in the weighted fusion process with some specific prediction modes.

In some embodiments, the method further includes: determining other prediction value for the current block using other prediction mode. The other prediction value includes one or more prediction values. Weighted fusion is performed on the prediction value of the current block and other prediction values to obtain the final prediction value of the current block.

That is, weighted fusion may be performed on the prediction value obtained by the TIMD mode provided by the embodiment of the present disclosure and other prediction value obtained by other prediction mode to obtain the prediction value of the current block.

Hereinafter, the prediction process is exemplified in which iBestMode is the first intra prediction mode, iSecondaryMode is the second intra prediction mode, and predSamples [x][y] are the prediction value of the current block.

If only one target prediction mode is selected by the TIMD, the weighted fusion is not performed, and the current block is predicted by iBestMode to obtain the final prediction value. That is, the predSamples [x][y] are directly obtained by the corresponding method of prediction mode, where x=0 . . . uiWidth−1, y=0 . . . uiHeight−1.

If more than one target prediction mode is selected by TIMD, the evaluation criterion of iBestMode and iSecondaryMode are uiBestCost and uiSecondaryCost, respectively.

The TIMD technology decides whether to apply weighted fusion based on the values of uiBestCost and uiSecondaryCost, which is described as follows:

If uiSecondaryCost>=2*uiBestCost, the weighted fusion is not applied, and the current block is predicted by using iBestMode to obtain the final prediction value.

If uiSecondaryCost <2*uiBestCost, weighted fusion is applied. The weight of iBestMode is set to be weight1 and the weight of iSecondaryMode is set to be weight2, which is described as follows:

weight1=uiSecondaryCost/(uiBestCost+uiSecondaryCost)

weight2=1−weight1

The current block obtains two prediction values (pelPred [x][y] and pelPredFusion [x][y], where x=0 . . . nTbW−1, y=0 . . . nTbH−1) by using iBestMode and iSecondaryMode. After that, weighted fusion is applied to obtain the final prediction value predSamples [x][y], which is described as follows:

predSamples[x][y]=pelPred[x][y]*weight1+pelPredFusion[x][y]*weight2

Further, when the target prediction mode includes the PLANAR_HOR mode and the PLANAR_VER mode, the prediction process includes the following operations.

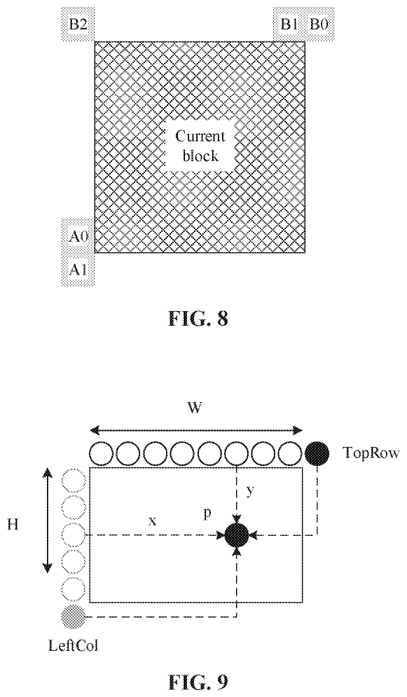

It is assumed that the width of the current block is W, the height of the current block is H, the reference pixel of the top reference row (topRow) is topRow [t], t=0 . . . W, the reference pixel of the left reference column (leftCol) is leftCol [l], l=0 . . . H, and the top left reference pixel is TL, as shown in FIG. 9, the topRow is expressed as black, the solid black denotes the upper right reference pixel topRow [W], the leftCol is expressed as gray, and the solid gray denotes the lower left reference pixel leftCol [H].

Then the prediction process of the PLANAR mode is described as follows: predSamples [x][y] denotes the prediction value, x=0 . . . W−1 and y=0 . . . H−1.

predV[x][y]=((H−1−y)*topRow[x]+(y+1)*leftCol[H])<<Log 2(W) Vertical prediction value:

predH[x][y]=((W−1−x)*leftCol[y]+(x+1)*topRow[W])<<Log 2(H) Horizontal prediction value:

The average of the vertical prediction value and the horizontal prediction value is calculated.

predSamples[x][y]=(predV[x][y]+predH[x][y]+W*H)>>(Log 2(W)+Log 2(H)+1)

The prediction process of the PLANAR_HOR mode is described as follows: predSamples [x][y] denotes the prediction values, x=0 . . . W−1 and y=0 . . . H−1.

predSamples[x][y]=((W−1−x)*leftCol[y]+(x+1)*topRow[W]+(1<<(Log 2(W)−1)))>>Log 2(W)

The prediction process of the PLANAR_VER mode is described as follows: predSamples [x][y] denotes the prediction values, x=0 . . . W−1 and y=0 . . . H−1.

predSamples[x][y]=((H−1−y)*topRow[x]+(y+1)*leftCol[H]+(1<<(Log 2(H)−1)))<<Log 2(H)
Log 2 (n) denotes the base-2 logarithm of n.

It should be noted that the prediction method of the TIMD Mode provided by the embodiment of the present disclosure may also involve other prediction modes, including but not limited to: Intra Sub-Partition (ISP), Multiple Reference Line intra prediction (MRL), Spatial Geometric Partitioning Mode (SGPM), and the like.

Exemplarily, the operation that a prediction value of the current block is determined according to the target prediction mode includes operations as follows. In a case that the prediction parameter indicates that the current block uses a Multiple Reference Line intra prediction (MRL) mode, a reference sample value of the current block is determined. The reference sample value includes a plurality of rows of reconstructed reconstruction sample values on the upper side of the current block, and/or a plurality of columns of reconstructed reconstruction sample values on the left side of the current block. The current block is predicted by using the target prediction mode according to the reference sample value of the current block, to obtain a prediction value of the current block. That is, the reference sample value of the current block may be multiple rows and multiple columns of reconstructed reconstruction sample values on the basis of using the TIMD mode.

Exemplarily, the prediction parameter may further include a second syntax element for indicating whether the current block uses the MRL mode. When the value of the second syntax element is 0, the MRL mode is not used. When the value of the second syntax element is 1, the MRL mode is used.

In some embodiments, the operation that a prediction value of the current block is determined according to the target prediction mode includes operations as follows. In a case where the prediction parameter indicates that the current block uses an Intra Sub-Partition (ISP) mode, a reference sample value for a sub-block of the current block is determined. The reference sample value includes one or more rows of reconstructed reconstruction sample values on the upper side of the sub-block, and/or one or more columns of reconstructed reconstruction sample values on the left side of the sub-block. The sub-block is predicted by using the target prediction mode according to the reference sample value of the sub-block, to obtain a prediction value of the sub-block. That is, on the basis of using the TIMD mode, the current block may be divided into sub-blocks, and each sub-block may be predicted. In addition, the reference sample value of each sub-block may be one row and one column of reconstructed reconstruction sample values, or may be multiple rows and multiple columns of reconstructed reconstruction sample values.

Exemplarily, the prediction parameter may further include a third syntax element for indicating whether the current block uses the ISP mode. When the value of the third syntax element is 0, the ISP mode is not used. When the value of the third syntax element is 1, the ISP mode is used.

In some embodiments, the operation that a prediction value of the current block is determined according to the target prediction mode includes operations as follows. In a case where the prediction parameter indicates that the current block uses a Spatial Geometric Partitioning Mode (SGPM), the current block is geometrically partitioned. A first partition of the current block is predicted by using the target prediction mode according to a reference sample value of the first partition, to obtain a prediction value of the first partition. That is, on the basis of using the TIMD mode, the current block may be spatially geometrically partitioned and one or more partitions may be predicted. In addition, the reference sample value of each partition may be one row and one column of reconstructed reconstruction sample values, or may be multiple rows and multiple columns of reconstructed reconstruction sample values.

Exemplarily, the prediction parameter may further include a fourth syntax element for indicating whether the SGPM mode is used in the current block. When the value of the fourth syntax element is 0, the SGPM mode is not used. When the value of the fourth syntax element is 1, the SGPM mode is used.

In some embodiments, on the basis of using the TIMD mode, and the PLANAR_HOR mode or the PLANAR_VER mode is selected as the target prediction mode, other prediction modes may be involved.

With the above technical solution, the correlation between the template and the current block is fully utilized, and one or more planar intra prediction modes are added for the TIMD mode as the candidate prediction modes, so that the TIMD mode may adaptively select a more matching prediction mode based on the template, thereby improving the prediction effect of the TIMD mode, and improving the efficiency of decoding.

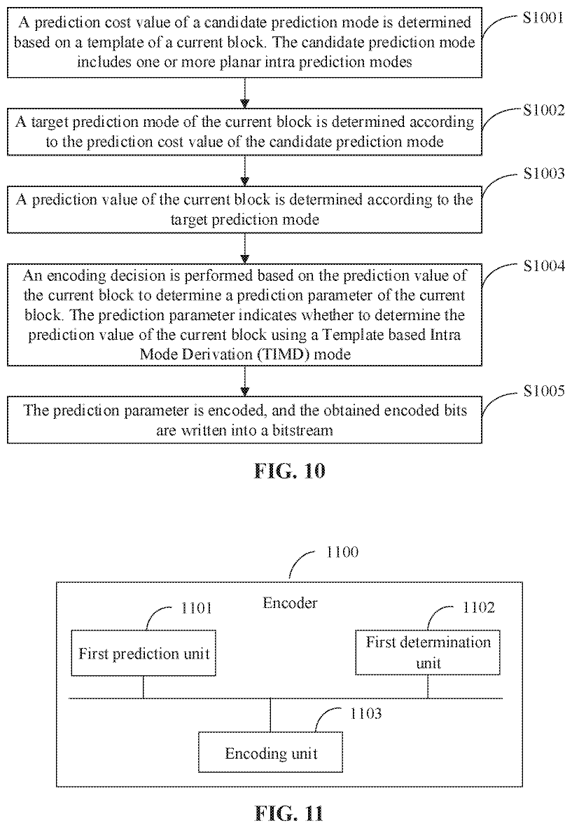

FIG. 10 is a schematic flowchart of an encoding method according to an embodiment of the present disclosure. As shown in FIG. 10, the encoding method may include the following operations S1001, S1002, S1003, S1004 and S1005.

At S1001, a prediction cost value of the candidate prediction mode is determined based on a template of a current block. The candidate prediction mode includes one or more planar intra prediction modes.

In some embodiments, the method further includes: determining the candidate prediction mode for the current block. The candidate prediction mode includes at least one or more planar intra prediction modes. Exemplarily, the one or more planar intra prediction modes include one or more of the planar prediction mode (PLANAR mode), a horizontal planar prediction mode (PLANAR_HOR mode), a vertical planar prediction mode (PLANAR_VER mode), and the like. The candidate prediction mode may also include other intra prediction modes different from the planar intra prediction modes.

Exemplarily, one or more intra prediction modes in a preset list of intra prediction modes are taken as the candidate prediction mode.

Exemplarily, the candidate prediction mode is determined based on the prediction mode of the reconstructed reference block of the current block. The reference block includes neighboring blocks and/or non-neighboring blocks of the current block. The reference block may include one or more neighboring blocks, which may be a left neighboring block, a lower left neighboring block, an upper right neighboring block, an upper neighboring block, a top left neighboring as shown in FIG. 8. The reference block may include one or more non-neighboring blocks. The reference block may include one or more neighboring blocks and one or more non-neighboring blocks.

In some embodiments, the operation that the candidate prediction mode is determined based on the prediction mode of the reconstructed reference block of the current block includes operations as follows. In a case that the prediction mode of the reference block includes the first planar intra prediction mode, it is determined that the candidate prediction mode includes the first planar intra prediction mode. The first planar intra prediction mode includes one or more planar intra prediction modes. In a case that the prediction mode of the reference block does not include the first planar intra prediction mode, it is determined that the candidate prediction mode includes the prediction mode of the reference block and the first planar intra prediction mode. That is, whether the candidate prediction mode includes the planar intra prediction mode and how many of planar intra prediction modes are included in the candidate prediction mode, are related to the prediction mode of the reference block, the candidate prediction mode includes one or more intra prediction modes in the reference block. The first planar intra prediction mode may be any planar intra prediction mode or a specific prediction mode. Exemplarily, the first planar intra prediction mode is the PLANAR_HOR mode or the PLANAR_VER mode.

It should be noted that, in addition to the first planar intra prediction mode, the candidate prediction mode includes other prediction modes of the neighboring blocks.

In other embodiments, the operation that the candidate prediction mode is determined based on the prediction mode of the reconstructed reference block of the current block includes: determining that the candidate prediction mode includes the prediction mode of the reference block and one or more planar intra prediction modes. That is, whether the candidate prediction mode includes the planar intra prediction modes and how many of planar intra prediction modes are included, are not related to the prediction mode in the reference block, and the candidate prediction mode includes one or more preset planar intra prediction modes regardless of whether the reference block has the planar intra prediction mode.

In some embodiments, the operation that the candidate prediction mode is determined based on the prediction mode of the reconstructed reference block of the current block further includes: in a case that none of the prediction mode of the reference block is available, determining that the candidate prediction mode further includes a planar prediction mode; or in a case that the prediction mode of the reference block is available but does not include an angle prediction mode, determining that the candidate prediction mode further includes a planar prediction mode and a DC prediction mode; or in a case that the prediction mode of the reference block includes an angle prediction mode, constructing a MPM list according to prediction mode of the reference block and determining at least one wide angle prediction mode of the reference block, where the MPM list includes one or more prediction modes; and determining that the candidate prediction mode includes one or more prediction modes in the MPM list, the at least one wide angle prediction mode, the DC prediction mode, a vertical angle prediction mode (VER mode), and a horizontal angle prediction mode (HOR mode).

In some embodiments, the operation that the candidate prediction mode is determined based on the prediction mode of the reconstructed reference block of the current block further includes: in a case that the prediction mode of the reference block includes a block-vector-based prediction mode (including IntraTmp, IBC, etc.), acquiring block vectors of one or more reference blocks; and determining a candidate block vector of the current block according to the block vectors of the one or more reference blocks. That is, if the candidate prediction mode of the current block includes the block-vector-based prediction mode, the candidate block vector of the current block is obtained according to the optimal block vector of the reference block, for realizing the block-vector-based prediction mode of the current block.

Hereinafter, a method for determining the candidate prediction mode in the embodiment of the present disclosure will be further illustrated.

The list of prediction modes is obtained, and the candidate prediction mode includes, but is not limited to the following mode categories: 67 intra prediction modes (the PLANAR mode, the DC mode, and 65 angle prediction modes), derived modes of the PLANAR mode such as the PLANAR_HOR mode and the PLANAR_VER mode, a block-vector-based prediction mode and the like.

A construction order of the list includes, but is not limited to, a prediction mode of neighboring blocks, a prediction mode of non-neighboring blocks, and the like. The derived modes of the PLANAR mode include, but are not limited to the following construction order, which may be included in the list or may be added according to the order of neighboring blocks or non-neighboring blocks.

A manner of acquiring 67 intra prediction modes is exemplified below, in which, the candidate prediction mode is selected according to the prediction mode of neighboring blocks (left, lower left, upper right, upper, and top left neighboring blocks) of the current block.

If there is no angle prediction mode in the neighboring blocks, the candidate prediction mode includes the PLANAR mode and the DC mode.

If there is an angle prediction mode in the neighboring blocks, the candidate prediction mode includes the MPM list and a wide-angle prediction mode. If one or more of the DC mode, the HOR mode and the VER mode are not in the MPM list, they are added at the end of the MPM list.

A manner of acquiring the derived modes of the PLANAR mode is exemplified below, including but not limited to the following operations.

If there is no PLANAR_HOR mode or PLANAR_VER mode in the neighboring blocks, the candidate prediction mode does not include either the PLANAR_HOR mode or the PLANAR_VER mode.

If there is at least one of the PLANAR_HOR mode or the PLANAR_VER mode in the neighboring blocks, the candidate prediction mode includes the PLANAR_HOR mode and/or PLANAR_VER mode of the neighboring block.

A manner of acquiring the block-vector-based prediction mode is exemplified below, in which, a block vector set is selected according to the prediction modes of the neighboring blocks (the left, lower left, upper right, upper, top left neighboring blocks) of the current coding block.

If there is no block-vector-based prediction mode in the neighboring blocks, there is no need to determine the candidate block vector.

If there is a block-vector-based prediction mode in the neighboring blocks, the candidate block vector includes a valid block vector of the neighboring blocks, the terms “valid” means that the reference block of the current block which is offset with respect to the block vector has been reconstructed.

In some embodiments, a template of the current block is predicted by using the candidate prediction mode to determine a first prediction sample value of the template of the current block. The prediction cost value of the candidate prediction mode is determined according to a first reconstruction sample value and the first prediction sample value of the template of the current block.

That is to say, by traversing different prediction modes, multiple sets of prediction information of the template may be obtained, and the optimal prediction mode may be selected according to the prediction cost value. The prediction cost value includes, but is not limited to, the Sum of Absolute Difference (SAD), the Sum of Absolute Transformed Difference (SATD), the Sum of Squared Errors (SSE), the Mean Absolute Deviation (MAD), the Mean Absolute Error (MAE), the Mean Square Error (MSE), the Rate Distortion Optimization (RDO), and the like.

At S1002, a target prediction mode of the current block is determined according to the prediction cost value of the candidate prediction mode.

Exemplarily, a first intra prediction mode corresponding to a minimum prediction cost value is determined according to the prediction cost value of the candidate prediction mode. The current block is predicted according to the first intra prediction value to obtain the prediction value of the current block. The first intra prediction mode may be understood as the optimal prediction mode selected in the TIMD mode, and the current block is predicted by the optimal prediction mode to obtain the prediction value of the current block in the TIMD mode.

Exemplarily, the first intra prediction mode corresponding to the minimum prediction cost value is determined according to the prediction cost value of the candidate prediction mode. A second intra prediction mode corresponding to the second smallest cost value is determined according to the prediction cost value of the candidate prediction mode. The second intra prediction mode includes one or more intra prediction modes. Weighted prediction is performed on the current block according to the first intra prediction mode and the second intra prediction mode to determine a prediction value of the current block. The second intra prediction mode may be understood as one or more sub-optimal prediction modes selected in the TIMD mode, and the weighted prediction is performed according to multiple intra prediction modes to obtain the prediction value of the current block in the TIMD mode.

That is, the target prediction mode may include one or more intra prediction modes, and the target prediction mode selected in the TIMD mode includes or does not include the planar intra prediction mode.

At S1003, a prediction value of the current block is determined according to the target prediction mode.

In some embodiments, the operation that a prediction value of the current block is determined according to the target prediction mode includes operations as follows. The first intra prediction mode is a horizontal planar prediction mode or a vertical planar prediction mode, the current block is predicted according to the first intra prediction mode to determine a prediction value of the current block; or the first intra prediction mode is a horizontal planar prediction mode or a vertical planar prediction mode, and the second intra prediction mode is a preset intra prediction mode, weighted prediction is performed on the current block according to the first intra prediction mode and the second intra prediction mode to determine a prediction value of the current block.

That is, when the horizontal planar prediction mode or the vertical planar prediction mode is selected as the optimal prediction mode in the TMID mode, the horizontal planar prediction mode or the vertical planar prediction mode may not involve in the weighted fusion process with other prediction modes, or only involves in the weighted fusion process with some specific prediction modes.

In some embodiments, the method further includes: determining other prediction value for the current block using other prediction mode. The other prediction value includes one or more prediction values. Weighted fusion is performed on the prediction value of the current block and other prediction values to obtain the final prediction value of the current block.

That is, weighted fusion may be performed on the prediction value obtained by the TIMD mode provided by the embodiment of the present disclosure and other prediction value obtained by other prediction mode to obtain the prediction value of the current block.

At S1004, an encoding decision is performed based on the prediction value of the current block to determine a prediction parameter of the current block. The prediction parameter indicates whether to determine the prediction value of the current block using a Template based Intra Mode Derivation (TIMD) mode.

It should be noted that the prediction parameter indicates whether the prediction value of the current block is determined using the Template based Intra Mode Derivation (TIMD) mode. If the prediction parameter indicates that the prediction value of the current block is determined using the TIMD mode, the subsequent step of performing prediction using the TIMD mode in the embodiment of the present disclosure is executed, and if the prediction parameter indicates that the prediction value of the current block is not determined using the TIMD mode, the prediction is performed using other prediction modes.

Exemplarily, the prediction parameter includes at least a first syntax element for indicating whether the prediction value of the current block is determined using a Template based Intra Mode Derivation (TIMD) mode, and when the value of the first syntax element is 0, the prediction value of the current block is not determined using the TIMD mode. When the value of the first syntax element is 1, the prediction value of the current block is determined using the TIMD mode.

In some embodiments, the method further includes determining a prediction parameter of the current block according to reference information of the current block. The reference information of the current block includes at least one of: a reference sample value of a reconstructed reference block of the current block, prediction information of the reference block, a size of the current block, a syntax element of the bitstream, and the like. That is, whether the current block uses the TIMD mode may be implicitly derived from the reference information of the current block.

At S1005, the prediction parameter is encoded, and the obtained encoded bits are written into a bitstream.

It should be noted that the prediction method of the TIMD Mode provided by the embodiment of the present disclosure may also involve other prediction modes, including but not limited to: Intra Sub-Partition (ISP), Multiple Reference Line intra prediction (MRL), Spatial Geometric Partitioning Mode (SGPM), and the like.

Exemplarily, the operation that a prediction value of the current block is determined according to the target prediction mode includes operations as follows. In a case that the prediction parameter indicates that the current block uses a Multiple Reference Line intra prediction (MRL) mode, a reference sample value of the current block is determined. The reference sample value includes a plurality of rows of reconstructed reconstruction sample values on the upper side of the current block, and/or a plurality of columns of reconstructed reconstruction sample values on the left side of the current block. The current block is predicted by using the target prediction mode according to the reference sample value of the current block, to obtain a prediction value of the current block. That is, the reference sample value of the current block may be multiple rows and multiple columns of reconstructed reconstruction sample values on the basis of using the TIMD mode.

Exemplarily, the prediction parameter may further include a second syntax element for indicating whether the current block uses the MRL mode. When the value of the second syntax element is 0, the MRL mode is not used. When the value of the second syntax element is 1, the MRL mode is used.

In some embodiments, the operation that a prediction value of the current block is determined according to the target prediction mode includes operations as follows. In a case where the prediction parameter indicates that the current block uses an Intra Sub-Partition (ISP) mode, a reference sample value for a sub-block of the current block is determined. The reference sample value includes one or more rows of reconstructed reconstruction sample values on the upper side of the sub-block, and/or one or more columns of reconstructed reconstruction sample values on the left side of the sub-block. The sub-block is predicted by using the target prediction mode according to the reference sample value of the sub-block, to obtain a prediction value of the sub-block. That is, on the basis of using the TIMD mode, the current block may be divided into sub-blocks, and each sub-block may be predicted. In addition, the reference sample value of each sub-block may be one row and one column of reconstructed reconstruction sample values, or may be multiple rows and multiple columns of reconstructed reconstruction sample values.

Exemplarily, the prediction parameter may further include a third syntax element for indicating whether the current block uses the ISP mode. When the value of the third syntax element is 0, the ISP mode is not used. When the value of the third syntax element is 1, the ISP mode is used.

In some embodiments, the operation that a prediction value of the current block is determined according to the target prediction mode includes operations as follows. In a case where the prediction parameter indicates that the current block uses a Spatial Geometric Partitioning Mode (SGPM), the current block is geometrically partitioned. A first partition of the current block is predicted by using the target prediction mode according to a reference sample value of the first partition, to obtain a prediction value of the first partition. That is, on the basis of using the TIMD mode, the current block may be spatially geometrically partitioned and one or more partitions may be predicted. In addition, the reference sample value of each partition may be one row and one column of reconstructed reconstruction sample values, or may be multiple rows and multiple columns of reconstructed reconstruction sample values.

Exemplarily, the prediction parameter may further include a fourth syntax element for indicating whether the SGPM mode is used in the current block. When the value of the fourth syntax element is 0, the SGPM mode is not used. When the value of the fourth syntax element is 1, the SGPM mode is used.

In some embodiments, on the basis of using the TIMD mode, and the PLANAR_HOR mode or the PLANAR_VER mode is selected as the target prediction mode, other prediction modes may be involved.

With the above technical solution, the correlation between the template and the current block is fully utilized, and one or more planar intra prediction modes are added for the TIMD mode as the candidate prediction modes, so that the TIMD mode may adaptively select a more matching prediction mode based on the template, thereby improving the prediction effect of the TIMD mode, and improving the efficiency of decoding.

In yet another embodiment of the present disclosure, based on the same inventive concept as the foregoing embodiments, FIG. 11 is a schematic diagram of a composition structure of an encoder according to an embodiment of the present disclosure. As shown in FIG. 11, the encoder 1100 may include a first prediction unit 1101, a first determination unit 1102, and an encoding unit 1103.

The first prediction unit 1101 is configured to determine a prediction cost value of a candidate prediction mode based on a template of a current block. The candidate prediction mode includes one or more planar intra prediction modes.

The first prediction unit 1101 is further configured to determine a target prediction mode of the current block according to the prediction cost value of the candidate prediction mode; and determine a prediction value of the current block according to the target prediction mode.

The first determination unit 1102 is configured to perform an encoding decision based on the prediction value of the current block to determine a prediction parameter of the current block. The prediction parameter indicates whether to determine the prediction value of the current block using a Template based Intra Mode Derivation (TIMD) mode.

The encoding unit 1103 is configured to encode the prediction parameter and write the obtained encoded bits into a bitstream.

In some embodiments, the first prediction unit 1101 is further configured to determine the candidate prediction mode according to a prediction mode of a reconstructed reference block of the current block. The reference block includes neighboring blocks and/or non-neighboring blocks of the current block.

In some embodiments, the first prediction unit 1101 is configured to, in a case that the prediction mode of the reference block includes a first planar intra prediction mode, determine that the candidate prediction mode includes the first planar intra prediction mode. The first planar intra prediction mode includes one or more planar intra prediction modes. The first prediction unit 1101 is configured to, in a case that the prediction mode of the reference block does not include the first planar intra prediction mode, determine that the candidate prediction mode includes the prediction mode of the reference block and the first planar intra prediction mode.

In some embodiments, the first prediction unit 1101 is configured to determine that the candidate prediction mode includes the prediction mode of the reference block and one or more planar intra prediction modes.

In some embodiments, the first prediction unit 1101 is configured to, in a case that none of the prediction mode of the reference block is available, determine that the candidate prediction mode further includes a planar prediction mode; or in a case that the prediction mode of the reference block is available but does not include an angle prediction mode, determine that the candidate prediction mode further includes a planar prediction mode and a direct current prediction mode; or in a case that the prediction mode of the reference block includes an angle prediction mode, construct a most probable mode (MPM) list according to prediction mode of the reference block and determine at least one wide angle prediction mode of the reference block, where the MPM list includes one or more prediction modes; and determine that the candidate prediction mode includes one or more prediction modes in the MPM list, the at least one wide angle prediction mode, the direct current prediction mode, a vertical angle prediction mode (VER mode), and a horizontal angle prediction mode (HOR mode).

In some embodiments, the first prediction unit 1101 is configured to, in a case that the prediction mode of the reference block includes a block-vector-based prediction mode, acquire block vectors of one or more reference blocks; and determine a candidate block vector of the current block according to the block vectors of the one or more reference blocks.

In some embodiments, the one or more planar intra prediction modes include one or more of the planar prediction mode, the horizontal planar prediction mode and the vertical planar prediction mode.

In some embodiments, the first prediction unit 1101 is configured to predict a template of the current block by using the candidate prediction mode to determine a first prediction sample value of the template of the current block; and determine a prediction cost value of the candidate prediction mode according to a first reconstruction sample value and the first prediction sample value of the template of the current block.

In some embodiments, the first prediction unit 1101 is configured to determine a first intra prediction mode corresponding to the minimum prediction cost value according to the prediction cost value of the candidate prediction mode; and determine a second intra prediction mode corresponding to the second smallest cost value according to the prediction cost value of the candidate prediction mode. The second intra prediction mode includes one or more intra prediction modes.

In some embodiments, the first prediction unit 1101 is configured to, in case that the first intra prediction mode is a horizontal planar prediction mode or a vertical planar prediction mode, predict the current block according to the first intra prediction mode to determine a prediction value of the current block; or in case that the first intra prediction mode is a horizontal planar prediction mode or a vertical planar prediction mode, and the second intra prediction mode is a preset intra prediction mode, perform weighted prediction on the current block according to the first intra prediction mode and the second intra prediction mode to determine a prediction value of the current block.

In some embodiments, the first prediction unit 1101 is configured to, in a case that the prediction parameter indicates that the current block uses a Multiple Reference Line intra prediction (MRL) mode, determine a reference sample value of the current block, where the reference sample value includes a plurality of rows of reconstructed reconstruction sample values on the upper side of the current block, and/or a plurality of columns of reconstructed reconstruction sample values on the left side of the current block; predict the current block by using the target prediction mode according to the reference sample value of the current block, to obtain a prediction value of the current block.

In some embodiments, the first prediction unit 1101 is configured to, in a case where the prediction parameter indicates that the current block uses an Intra Sub-Partition (ISP) mode, determine a reference sample value for a sub-block of the current block, where the reference sample value includes one or more rows of reconstructed reconstruction sample values on the upper side of the sub-block, and/or one or more columns of reconstructed reconstruction sample values on the left side of the sub-block, and predict the sub-block by using the target prediction mode according to the reference sample value of the sub-block, to obtain a prediction value of the sub-block.

In some embodiments, the first prediction unit 1101 is configured to, in a case where the prediction parameter indicates that the current block uses a Spatial Geometric Partitioning Mode (SGPM), partition the current block geometrically; and predict a first partition of the current block by using the target prediction mode according to a reference sample value of the first partition, to obtain a prediction value of the first partition.

In some embodiments, the target prediction mode is a horizontal planar prediction mode or a vertical planar prediction mode.

In the embodiments of the present disclosure, the “unit” may be a circuit portion, a processor portion, a program or software portion, or the like, and may also be a module, or may also be non-modular. In addition, all the components in the embodiments of the present disclosure may be integrated in one processing unit, or each may be physically present alone, or two or more units may be integrated in one unit. The integrated units mentioned above may be implemented in the form of hardware or software function module.

When the integrated units are implemented in the form of software function module rather than being sold or used as an independent product, the integrated units may be stored in a computer-readable storage medium. Based on this understanding, the technical solution of the present disclosure essentially or a part of the technical solution that contributes to the prior art or all or a part of the technical solution may be embodied in the form of a software product, the computer software product is stored in a storage medium, includes several instructions for causing a computer device (which may be a personal computer, server, or network device, etc.) or a processor to perform all or a part of the steps of the method described in various embodiments of the present disclosure. The above storage medium includes a USB disk, a removable hard disk, a Read Only Memory (ROM), a Random Access Memory (RAM), a magnetic disk, or an optical disk or a medium capable of storing program codes.

Therefore, the embodiments of the present disclosure provide a computer-readable storage medium, applied to the encoder 1100, on which a computer program is stored. The computer program is executed by a first processor to implement any one of the methods in the embodiments described above.

An embodiment of the present disclosure provides a computer-readable storage medium for storing a bitstream generated by the encoding method described above.

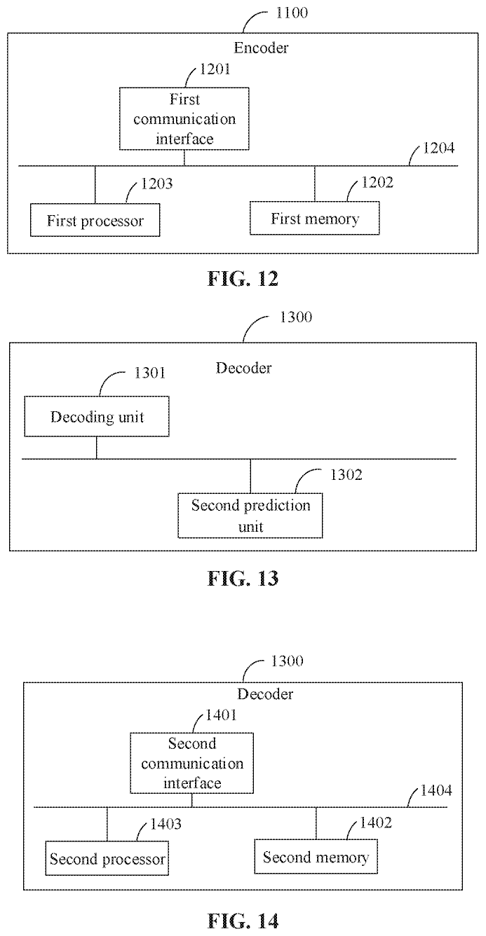

Based on the composition of the encoder 1100 and the computer-readable storage medium, FIG. 12 shows a schematic diagram of a specific hardware structure of the encoder 120 according to an embodiment of the present disclosure. As shown in FIG. 12, the encoder 1100 may include a first communication interface 1201, a first memory 1202, and a first processor 1203. The various components are coupled together by a first bus system 1204. It is understandable that the first bus system 1204 is used to implement connection communication between these components. The first bus system 1204 includes a power bus, a control bus, and a state signal bus in addition to a data bus. However, for clarity of explanation, the various buses are denoted as a first bus system 1204 in FIG. 12.

The first communication interface 1201 is configured to receive and send signals in the process of transmitting and sending information with other external network elements.

The first memory 1202 is configured to store a computer program executable on the first processor 1203.

The first processor 1203 is configured to, when running a computer program, implement:
determining a prediction cost value of a candidate prediction mode based on a template of a current block, where the candidate prediction mode includes one or more planar intra prediction modes;
determining a target prediction mode of the current block according to the prediction cost value of the candidate prediction mode;
determine a prediction value of the current block according to the target prediction mode.
performing an encoding decision based on the prediction value of the current block to determine a prediction parameter of the current block, where the prediction parameter indicates whether to determine the prediction value of the current block using a Template based Intra Mode Derivation (TIMD) mode; and
encoding the prediction parameter, and writing the obtained encoded bits into a bitstream.

It is understood that the first memory 1202 in the embodiments of the present disclosure may be a volatile memory or a non-volatile memory, or may include both volatile and non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which serves as an external cache. By way of illustration, but not limitation, many forms of RAMs are available, such as a static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM) and a Direct Rambus RAM (DR RAM). The first memory 1202 in the systems and methods described herein is intended to include, but is not limited to, these and any other suitable type of memory.

The first processor 1203 may be an integrated circuit chip having the signal processing capability. In the implementation process, the steps of the method described above may be completed by integrated logic circuits of hardware in the first processor 1203 or instructions in the form of software. The first processor 1203 described above may be a general-purpose processor, a Digital Signal Processor (DSP), an Application Specific Integrated Circuit (ASIC), a Field Programmable Gate Array (FPGA) or other programmable logic device, a discrete gate or a transistor logic device, or a discrete hardware component, to implement or execute the methods, steps, and logical blocks disclosed in the embodiments of the present disclosure. The general-purpose processor may be a microprocessor or the processor may be any conventional processor or the like. The steps of the method disclosed in connection with the embodiments of the present disclosure may be directly executed by the hardware decoding processor, or may be executed by combining hardware and software modules in the decoding processor. The software module may be provided in a storage medium mature in the art, such as a random-access memory, a flash memory, a read-only memory, a programmable read-only memory, or an electrically erasable programmable memory, a register, etc. The storage medium is arranged in the first memory 1202, and the first processor 1203 reads the information in the first memory 1202, to implement the steps of the above method in combination with the hardware thereof.

It will be understood that the embodiments described herein may be implemented in hardware, software, firmware, middleware, microcode, or a combination thereof. For hardware implementation, the processing unit may be implemented in one or more Application Specific Integrated Circuits (ASIC), a Digital Signal Processor (DSP), a DSP Device (DSPD), a Programmable Logic Device (PLD), a Field-Programmable Gate Array (FPGA), a general-purpose processor, a controller, a microcontroller, a microprocessor, or other electronic unit for executing the functions of the present disclosure or a combination thereof. For software implementation, the techniques of the present disclosure may be implemented by modules (e.g., procedures, functions, etc.) that perform the functions of the present disclosure. The software code may be stored in memory and executed by a processor. The memory may be implemented inside the processor or external to the processor.

Optionally, as another embodiment, the first processor 1203 is further configured to execute the method of any one of the embodiments mentioned above when running a computer program.

The present embodiment provides an encoder in which the correlation between the template and the current block is fully utilized, and one or more planar intra prediction modes are added as the candidate prediction modes for the TIMD mode, so that the TIMD mode may adaptively select a more matching prediction mode based on the template, thereby improving the prediction effect of the TIMD mode, and improving the efficiency of encoding.

In yet another embodiment of the present disclosure, based on the same inventive concept as the foregoing embodiments, FIG. 13 shows a schematic diagram of a composition structure of a decoder 1300 according to an embodiment of the present disclosure. As shown in FIG. 13, the decoder 1300 may include: a decoding unit 1301 and a second prediction unit 1302.

The decoding unit 1301 is configured to decode a bitstream to determine a prediction parameter of a current block.

The second prediction unit 1302 is configured to, in a case that the prediction parameter indicates determining a prediction value for the current block using a Template based Intra Mode Derivation (TIMD) mode, determine a prediction cost value of a candidate prediction mode based on a template of the current block. The candidate prediction mode includes one or more planar intra prediction modes.

The second prediction unit 1302 is further configured to determine a target prediction mode of the current block according to the prediction cost value of the candidate prediction mode; and determine a prediction value of the current block according to the target prediction mode.

In some embodiments, the second prediction unit 1302 is further configured to determine the candidate prediction mode according to a prediction mode of a reconstructed reference block of the current block. The reference block includes neighboring blocks and/or non-neighboring blocks of the current block.

In some embodiments, the second prediction unit 1302 is configured to, in a case that the prediction mode of the reference block includes a first planar intra prediction mode, determine that the candidate prediction mode includes the first planar intra prediction mode. The first planar intra prediction mode includes one or more planar intra prediction modes. The second prediction unit 1302 is configured to, in a case that the prediction mode of the reference block does not include the first planar intra prediction mode, determine that the candidate prediction mode includes the prediction mode of the reference block and the first planar intra prediction mode.

In some embodiments, the second prediction unit 1302 is configured to determine that the candidate prediction mode includes the prediction mode of the reference block and one or more planar intra prediction modes.

In some embodiments, the second prediction unit 1302 is configured to, in a case that none of the prediction mode of the reference block is available, determine that the candidate prediction mode further includes a planar prediction mode; or in a case that the prediction mode of the reference block is available but does not include an angle prediction mode, determine that the candidate prediction mode further includes a planar prediction mode and a direct current prediction mode; or in a case that the prediction mode of the reference block includes an angle prediction mode, construct a most probable mode (MPM) list according to prediction mode of the reference block and determine at least one wide angle prediction mode of the reference block, where the MPM list includes one or more prediction modes; and determine that the candidate prediction mode includes one or more prediction modes in the MPM list, the at least one wide angle prediction mode, the direct current prediction mode, a vertical angle prediction mode (VER mode), and a horizontal angle prediction mode (HOR mode).

In some embodiments, the second prediction unit 1302 is configured to, in a case that the prediction mode of the reference block includes a block-vector-based prediction mode, acquire block vectors of one or more reference blocks; and determine a candidate block vector of the current block according to the block vectors of the one or more reference blocks.

In some embodiments, the one or more planar intra prediction modes include one or more of the planar prediction mode, the horizontal planar prediction mode and the vertical planar prediction mode.

In some embodiments, the second prediction unit 1302 is configured to predict a template of the current block by using the candidate prediction mode to determine a first prediction sample value of the template of the current block; and determine a prediction cost value of the candidate prediction mode according to a first reconstruction sample value and the first prediction sample value of the template of the current block.

In some embodiments, the second prediction unit 1302 is configured to determine a first intra prediction mode corresponding to the minimum prediction cost value according to the prediction cost value of the candidate prediction mode; and determine a second intra prediction mode corresponding to the second smallest cost value according to the prediction cost value of the candidate prediction mode. The second intra prediction mode includes one or more intra prediction modes.

In some embodiments, the second prediction unit 1302 is configured to, in case that the first intra prediction mode is a horizontal planar prediction mode or a vertical planar prediction mode, predict the current block according to the first intra prediction mode to determine a prediction value of the current block; or in case that the first intra prediction mode is a horizontal planar prediction mode or a vertical planar prediction mode, and the second intra prediction mode is a preset intra prediction mode, perform weighted prediction on the current block according to the first intra prediction mode and the second intra prediction mode to determine a prediction value of the current block.

In some embodiments, the second prediction unit 1302 is configured to, in a case that the prediction parameter indicates that the current block uses a Multiple Reference Line intra prediction (MRL) mode, determine a reference sample value of the current block, where the reference sample value includes a plurality of rows of reconstructed reconstruction sample values on the upper side of the current block, and/or a plurality of columns of reconstructed reconstruction sample values on the left side of the current block; predict the current block by using the target prediction mode according to the reference sample value of the current block, to obtain a prediction value of the current block.

In some embodiments, the second prediction unit 1302 is configured to, in a case where the prediction parameter indicates that the current block uses an Intra Sub-Partition (ISP) mode, determine a reference sample value for a sub-block of the current block, where the reference sample value includes one or more rows of reconstructed reconstruction sample values on the upper side of the sub-block, and/or one or more columns of reconstructed reconstruction sample values on the left side of the sub-block, and predict the sub-block by using the target prediction mode according to the reference sample value of the sub-block, to obtain a prediction value of the sub-block.

In some embodiments, the second prediction unit 1302 is configured to, in a case where the prediction parameter indicates that the current block uses a Spatial Geometric Partitioning Mode (SGPM), partition the current block geometrically; and predict a first partition of the current block by using the target prediction mode according to a reference sample value of the first partition, to obtain a prediction value of the first partition.

In some embodiments, the target prediction mode is a horizontal planar prediction mode or a vertical planar prediction mode.

Based on the composition of the decoder 1300 and the computer-readable storage medium, FIG. 14 shows a schematic diagram of a specific hardware structure of the decoder 1300 according to an embodiment of the present disclosure. As shown in FIG. 14, the decoder 1300 may include: a second communication interface 1401, a second memory 1402, and a second processor 1403. The various components are coupled together by a second bus system 1404. It is understood that the second bus system 1404 is used to implement connection communication between these components. The second bus system 1404 includes a power bus, a control bus, and a state signal bus in addition to a data bus. However, for clarity of explanation, the various buses are denoted as a second bus system 1404 in FIG. 14.

The second communication interface 1401 is configured to receive and send signals in the process of sending and receiving information with other external network elements.

The second memory 1402 is configured to store a computer program executable on the second processor 1403.

The second processor 1403 is configured to, when running the computer program, implement:
decoding a bitstream to determine a prediction parameter of the current block;
in a case that the prediction parameter indicates determining a prediction value of the current block using the Template based Intra Mode Derivation (TIMD) mode, determining a prediction cost value of a candidate prediction mode based on a template of the current block, where the candidate prediction mode includes one or more planar intra prediction modes;
determining a target prediction mode of the current block according to the prediction cost value of the candidate prediction mode; and
determining a prediction value of the current block according to the target prediction mode.

It is understood that the hardware function of the second memory 1402 is similar to the hardware function of the first memory 1202, and the hardware function of the second processor 1403 is similar to the hardware function of the first processor 1203. It will not be described in detail here.

The present embodiment provides a decoder in which the correlation between the template and the current block is fully utilized, and one or more planar intra prediction modes are added for the TIMD mode as the candidate prediction modes, so that the TIMD mode may adaptively select a more matching prediction mode based on the template, thereby improving the prediction effect of the TIMD mode, and improving the efficiency of decoding.

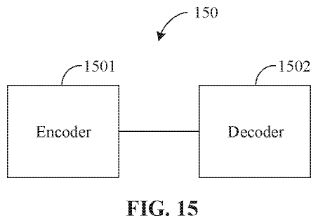

In another embodiment of the present disclosure, FIG. 15 is a schematic flowchart of a composition structure of a codec system according to an embodiment of the present disclosure. As shown in FIG. 15, the codec system 150 may include an encoder 1501 and a decoder 1502.

In the embodiment of the present disclosure, the encoder 1501 may be the encoder of any one of the preceding embodiments, and the decoder 1502 may be the decoder of any one of the preceding embodiments.

It should be noted that, herein, the terms “comprise”, “include”, or any other variation thereof herein are intended to encompass a non-exclusive inclusion such that a process, a method, an article, or a device including a series of elements includes not only those elements, but also other elements that are not explicitly listed, or includes elements inherent to such the process, the method, the article, or the device. Without further limitation, an element defined by the statement “comprising a . . . ” does not preclude the presence of additional identical elements in the process, the method, the article, or the device that includes the elements.

The above-described order numbers of the embodiments of the present disclosure are for description only, and do not represent the advantages and disadvantages of the embodiments.

The methods disclosed in several method embodiments provided in the present disclosure may be arbitrarily combined without conflict to obtain new method embodiments.

The features disclosed in several product embodiments provided in the present disclosure may be arbitrarily combined without conflict to obtain new product embodiments.

The features disclosed in several method embodiments or apparatus embodiments provided in the present disclosure may be arbitrarily combined without conflict to obtain the new method embodiments or apparatus embodiments.

The foregoing is merely a specific embodiment of the present disclosure, but the scope of protection of the present disclosure is not limited thereto, and changes or substitutions easily conceived by any person skilled in the art within the technical scope disclosed in the present disclosure should be covered within the scope of protection of the present disclosure. Therefore, the scope of protection of the present disclosure should be subject to the scope of protection of the claims.

### INDUSTRIAL PRACTICALITY

The embodiments of the present disclosure provide an encoding method, a decoding method, an encoder, a decoder, and a storage medium. Whether at an encoding end or a decoding end, in case that the prediction value of the current block is determined by using a Template based Intra Mode Derivation (TIMD) mode, the prediction cost value of candidate prediction mode is determined based on a template of the current block. The candidate prediction mode includes one or more planar intra prediction modes. A target prediction mode of the current block is determined according to the prediction cost value of the candidate prediction mode. A prediction value of the current block is determined according to the target prediction mode. In this way, the correlation between the template and the current block is fully utilized, and one or more PLANAR intra prediction modes are added as the candidate prediction mode for the TIMD mode, so that the TIMD mode may adaptively select a matching prediction mode based on the template, thereby improving the prediction effect of the TIMD mode, and improving the efficiency of the encoding and decoding.

1. A decoding method, applied to a decoder, comprising:
decoding a bitstream to determine a prediction parameter of a current block;
in response to the prediction parameter indicating determining a prediction value for the current block using a Template based Intra Mode Derivation (TIMD) mode, determining a prediction cost value of a candidate prediction mode based on a template of the current block, wherein the candidate prediction mode comprises one or more planar intra prediction modes;
determining a target prediction mode of the current block according to the prediction cost value of the candidate prediction mode; and
determining a prediction value of the current block according to the target prediction mode.

2. The method of claim 1, further comprising:
determining the candidate prediction mode according to a prediction mode of a reconstructed reference block of the current block, wherein the reference block comprises at least one of a neighboring block or a non-neighboring block of the current block.

3. The method of claim 2, wherein the determining the candidate prediction mode according to a prediction mode of a reconstructed reference block of the current block comprises:
in response to the prediction mode of the reference block comprising a first planar intra prediction mode, determining that the candidate prediction mode comprises the first planar intra prediction mode, wherein the first planar intra prediction mode comprises one or more planar intra prediction modes; and
in response to the prediction mode of the reference block not comprising a first planar intra prediction mode, determining that the candidate prediction mode comprises the prediction mode of the reference block and the first planar intra prediction mode.

4. The method of claim 2, wherein the determining the candidate prediction mode according to a prediction mode of a reconstructed reference block of the current block comprises:
determining that the candidate prediction mode comprises the prediction mode of the reference block and one or more planar intra prediction modes.

5. The method of claim 3, wherein the determining the candidate prediction mode according to a prediction mode of a reconstructed reference block of the current block comprises:
in response to none of the prediction mode of the reference block is available, determining that the candidate prediction mode further comprises a planar prediction mode; or
in response to the prediction mode of the reference block is available but does not comprise an angle prediction mode, determining that the candidate prediction mode further comprises a planar prediction mode and a direct current prediction mode; or
in response to the prediction mode of the reference block comprises an angle prediction mode, constructing a most probable mode list according to the prediction mode of the reference block, and determining at least one wide angle prediction mode of the reference block, wherein the most probable mode list comprises one or more prediction modes; and
determining that the candidate prediction mode comprises one or more prediction modes of: the one or more prediction modes in the most probable mode list, the at least one wide angle prediction mode, the direct current prediction mode, a vertical angle prediction mode, and a horizontal angle prediction mode.

6. The method of claim 3, wherein the determining the candidate prediction mode according to a prediction mode of a reconstructed reference block of the current block comprises:
in response to the prediction mode of the reference block comprises a block-vector-based prediction mode, obtaining block vectors of one or more reference blocks; and
determining a candidate block vector of the current block according to the block vectors of the one or more reference blocks.

7. The method of claim 1, wherein the one or more planar intra prediction modes comprise one or more of the planar prediction mode, a horizontal planar prediction mode and a vertical planar prediction mode.

8. The method of claim 1, wherein the determining a prediction cost value of the candidate prediction mode based on a template of the current block comprises:
predicting a template of the current block by using the candidate prediction mode to determine a first prediction sample value of the template of the current block; and
determining a prediction cost value of the candidate prediction mode according to a first reconstruction sample value and the first prediction sample value of the template of the current block.

9. The method of claim 1, wherein the determining a target prediction mode of the current block according to the prediction cost value of the candidate prediction mode comprises:
determining a first intra prediction mode corresponding to a minimum prediction cost value according to the prediction cost value of the candidate prediction mode; and
determining a second intra prediction mode corresponding to a second smallest cost value according to the prediction cost value of the candidate prediction mode, wherein the second intra prediction mode comprises one or more intra prediction modes.

10. The method of claim 9, wherein the determining a prediction value of the current block according to the target prediction mode comprises:
in response to the first intra prediction mode being a horizontal planar prediction mode or a vertical planar prediction mode, predicting the current block according to the first intra prediction mode to determine a prediction value of the current block; or
in response to the first intra prediction mode being a horizontal planar prediction mode or a vertical planar prediction mode, and the second intra prediction mode being a preset intra prediction mode, performing weighted prediction on the current block according to the first intra prediction mode and the second intra prediction mode to determine a prediction value of the current block.

11. The method of claim 1, wherein the determining a prediction value of the current block according to the target prediction mode comprises:
in response to the prediction parameter indicating that the current block uses a Multiple Reference Line intra prediction mode, determining a reference sample value of the current block, wherein the reference sample value comprises at least one of a plurality of rows of reconstructed reconstruction sample values on the upper side of the current block, or a plurality of columns of reconstructed reconstruction sample values on the left side of the current block; and
predicting the current block by using the target prediction mode according to the reference sample value of the current block, to obtain a prediction value of the current block.

12. The method of claim 1, wherein the determining a prediction value of the current block according to the target prediction mode comprises:
in response to the prediction parameter indicating that the current block uses an Intra Sub-Partition mode, determining a reference sample value of a sub-block of the current block, wherein the reference sample value comprises at least one of one or more rows of reconstructed reconstruction sample values on the upper side of the sub-block, or one or more columns of reconstructed reconstruction sample values on the left side of the sub-block; and
predicting the sub-block by using the target prediction mode according to the reference sample value of the sub-block, to obtain a prediction value of the sub-block.

13. The method of claim 1, wherein the determining a prediction value of the current block according to the target prediction mode comprises:
in response to the prediction parameter indicating that the current block uses a Spatial Geometric Partitioning Mode, geometrically partitioning the current block; and
predicting a first partition in the current block by using the target prediction mode according to a reference sample value of the first partition, to obtain a prediction value of the first partition.

14. The method of claim 11, wherein the target prediction mode is a horizontal planar prediction mode or a vertical planar prediction mode.

15. An encoding method, applied to an encoder, comprising:
determining a prediction cost value of a candidate prediction mode based on a template of a current block, wherein the candidate prediction mode comprises one or more planar intra prediction modes;
determining a target prediction mode of the current block according to the prediction cost value of the candidate prediction mode;
determining a prediction value of the current block according to the target prediction mode;
performing an encoding decision based on the prediction value of the current block to determine a prediction parameter of the current block, wherein the prediction parameter indicates whether to determine the prediction value of the current block using a Template based Intra Mode Derivation mode; and
encoding the prediction parameter, and writing the obtained encoded bits into a bitstream.

16. The method of claim 15, further comprising:
determining the candidate prediction mode according to a prediction mode of a reconstructed reference block of the current block, wherein the reference block comprises at least one of a neighboring block or a non-neighboring block of the current block.

17. The method of claim 16, wherein the determining the candidate prediction mode according to a prediction mode of a reconstructed reference block of the current block comprises:
in response to the prediction mode of the reference block comprising a first planar intra prediction mode, determining that the candidate prediction mode comprises the first planar intra prediction mode, wherein the first planar intra prediction mode comprises one or more planar intra prediction modes; and
in response to the prediction mode of the reference block not comprising a first planar intra prediction mode, determining that the candidate prediction mode comprises the prediction mode of the reference block and the first planar intra prediction mode.

18. The method of claim 17, wherein the determining the candidate prediction mode according to a prediction mode of a reconstructed reference block of the current block comprises:
in response to none of the prediction mode of the reference block is available, determining that the candidate prediction mode further comprises a planar prediction mode; or
in response to the prediction mode of the reference block is available but does not comprise an angle prediction mode, determining that the candidate prediction mode further comprises a planar prediction mode and a direct current prediction mode; or
in response to the prediction mode of the reference block comprises an angle prediction mode, constructing a most probable mode list according to the prediction mode of the reference block, and determining at least one wide angle prediction mode of the reference block, wherein the most probable mode list comprises one or more prediction modes; and
determining that the candidate prediction mode comprises one or more prediction modes of: the one or more prediction modes in the most probable mode list, the at least one wide angle prediction mode, the direct current prediction mode, a vertical angle prediction mode, and a horizontal angle prediction mode.

19. The method of claim 15, wherein the one or more planar intra prediction modes comprise one or more of the planar prediction mode, a horizontal planar prediction mode and a vertical planar prediction mode.

20. A non-transitory computer-readable storage medium having a computer program and a bitstream stored thereon, wherein the computer program, when executed by a processor, enables the processor to perform following steps to generate the bitstream:
determining a prediction cost value of a candidate prediction mode based on a template of a current block, wherein the candidate prediction mode comprises one or more planar intra prediction modes;
determining a target prediction mode of the current block according to the prediction cost value of the candidate prediction mode;
determining a prediction value of the current block according to the target prediction mode;
performing an encoding decision based on the prediction value of the current block to determine a prediction parameter of the current block, wherein the prediction parameter indicates whether to determine the prediction value of the current block using a Template based Intra Mode Derivation mode; and
encoding the prediction parameter, and writing the obtained encoded bits into the bitstream.
